(19) United States
(12) Patent Application Publication
(10) Pub. No.: US 2010/0095625 A1
(43) Pub. Date: Apr. 22, 2010

(54) Rigid foam insulating panel with compressible joint

(76) Inventors: Zine-Eddine Boutaghou, North Oaks, MN (US); Karl Schwappach, North Oaks, MN (US)

Correspondence Address: Karl G Schwappach, 17 south Long Lake Trail, North Oaks, MN, 55127, US

(21) Appl. No.: 12/288,432

(22) Filed: Oct. 20, 2008

(51) Int. Cl. E04B 2/56; B32B 3/00; E04B 1/74

(52) U.S. Cl. 52/506.01; 428/57; 52/309.4; 52/741.4

(57) ABSTRACT

An insulating panel including a panel structure of closed cell foam with a first portion and a second portion. At least one compressible joint connects the first portion to the second portion. The compressible joint includes at least one segment with a cross-sectional thickness less than a cross-sectional thickness of the panel structure.

### FIELD OF THE INVENTION

The present invention is directed to a compressible joint formed in a rigid foam insulting panel.

### BACKGROUND OF THE INVENTION

Current practice of applying foam to insulate homes/businesses generates a lot of waste products such as disposal of containers, hazardous outgasing, and rework difficulties. The sprayed insulation foam ages over time and loses its insulation properties. Commercial manufacturing settings provide ideal conditions for fabricating insulation panels with very high insulation R factors ranging from 8-10 per inch. However, fitting the current insulation panels to existing homes is labor intensive and not readily practical. It is extremely desirable to use polystyrene manufactured in a commercial environment as an insulation material readily mountable in existing wall and ceiling spaces.

Current foam based insulation panels are manufactured using polystyrene and polyisocyanurate. Extrusion is a preferred manufacturing method for insulation panels due to its speed and accuracy. Other mold injection methods are also practiced for specialty applications.

In use, the foams are then cut on-site to fit specific dimensions between wall studs and/or ceiling studs. Once the foams are cut into desired dimensions it is necessary to seal the joints between the wall studs and the foam to prevent air infiltration from taking place and/or to attach the foam to the studs. This process is time consuming and labor intensive, and thus, not often performed in practice.

### BRIEF SUMMARY OF THE INVENTION

The present invention provides a compressible joint capable of allowing for an insulation panel to be compressed prior to insertion between wall studs. The compressible joint is preferably elastic allowing for relatively easy flexing and/or compression of the panel to allow for insertion. Once the flexible panel is inserted between the wall studs, the deformed compressible joint applies a lateral force to seal the space between the wall studs and the insulation panel. The compressible joint can be located in one or more locations in the central portion of the insulating panel, along one or more edges, or some combination thereof.

In some embodiments, to enhance the sealing performance of the edges of the foam panel, multiple air fin features are fabricated on the insulation panel to permit maximum engagement between the wall studs and the panel edges. In one embodiment, the air fins features comprise triangular extruded features where the triangular apex (peak) is pushed against the wall studs creating an airtight seal. The deflection and/or deformation of the air fins allows for airtight joints without the need to apply additional foam or other sealants to the insulation panel. The air fins also help to secure the foam in the space between the studs.

The insulation panels are fabricated with a compressible joint located preferably at one of the panel ends along the entire length of the panel. The insulation panel is slightly larger than the spacing between the studs. The force exerted by the panel against the wall studs is determined by the interference of the panel and the wall studs times the stiffness of the compressible joint.

In one embodiment, the insulating panel includes a panel structure of closed cell foam with a first portion and a second portion. At least one compressible joint connects the first portion to the second portion. The compressible joint includes at least one segment with a cross-sectional thickness less than a cross-sectional thickness of the panel structure.

The compressible joint is preferably elastically deformable in response to a compressive force is applied to side edges of the panel structure. In one embodiment, the segments of the compressible joint are oriented at an angle with respect to first and second major surfaces of the panel structure. The segments can optionally be curvilinear. The compressible joint is optionally a closed structure. The segments are preferably configured to deform symmetrically in response to a compression force is applied to side edges of the panel structure. The compressible joint in a fully compressed configuration is preferably located substantially between first and second major surfaces of the panel structure.

The compressible joint in a compressed configuration preferably generates an expansion force generally parallel to first and second major surfaces of the panel structure. At least one deformable fin is optionally located on side edges of the panel structure.

The insulating panel optionally includes a plurality of parallel compressible joints. In one embodiment, the insulating panel includes a plurality of non-parallel compressible joints. The compressible joints can also serve as score lines for cutting or snapping the insulating panel into the desired sizes.

The compressible joint permits the first portion of the panel structure to move in at least two degrees of freedom relative to the second portion of the panel structure. In another embodiment, the insulating panel includes a plurality of non-parallel compressible joints that permit the first portion of the panel structure to move in three degrees of freedom relative to the second portion of the panel structure.

The major surfaces of the insulating panel are optionally a non-rectangular shape. The panel structure and the compressible joint are preferably a monolithic structure. The first and second portions and the compressible joint are preferably a unitary structure integrally formed from the closed cell foam.

The panel structure is optionally a multi-layered structure. A flexible sheet optionally extends across the compressible joint to the first and second portions of the panel structure. In another embodiment, a flexible sheet is located in the compressible joint. In yet another embodiment, a flexible sheet is co-extruded inside at least the compressible joint.

In another embodiment, the present insulating panel includes a panel structure of closed cell foam with a plurality of side edges. At least one compressible joint extends along at least of one of the side edges. The compressible joint includes at least one segment with a cross-sectional thickness less than a cross-sectional thickness of the panel structure. In this embodiment, the compressible joint is one or more fins.

An embodiment of the present invention is also directed to a method of installing an insulating panel. The insulting panel is sized slightly larger than a space between two opposing surfaces. A compressive force is applied to a compressible joint connecting first and second portion of the panel structure so the insulating panel is slightly smaller than the space between the opposing surfaces. The insulating panel is located between the opposing surfaces. The compressive force is released. An expansion force is generated by the compressible joint that is transmitted through the first and second portions of the panel structure to the opposing surfaces.

### BRIEF DESCRIPTION OF THE SEVERAL VIEWS OF THE DRAWING

FIG. 1 is a perspective view of an insulating panel with a compressible joint in accordance with an embodiment of the present invention.

FIG. 2 is a perspective view of a compressible joint without a compressive load in accordance with an embodiment of the present invention.

FIG. 3 is a perspective view of the compressible joint of FIG. 2 subject to a compressive load in accordance with an embodiment of the present invention.

FIG. 4 is a perspective view of an alternate compressive joint for an insulating panel in accordance with an embodiment of the present invention.

FIG. 5 is a perspective view of an insulating panel with a compressive joint engaged with a wall in accordance with an embodiment of the present invention.

FIG. 6 is an end view of compressible joints located along edges of an insulating panel in accordance with an embodiment of the present invention.

FIG. 7 is a perspective view of the insulating panel of FIG. 6 engaged with a wall structure in accordance with an embodiment of the present invention.

FIG. 8 is a plan view of an insulating panel with a plurality of compressible joints in accordance with an embodiment of the present invention.

FIG. 9 is a sectional view of a compressible joint in a composite insulating panel in accordance with an embodiment of the present invention.

FIG. 10 is a sectional view of an alternate compressible joint in accordance with an embodiment of the present invention.

FIG. 11 is a plan view of an insulating panel with non-orthogonal compressible joints in accordance with an embodiment of the present invention.

FIG. 12 illustrates independent movement of a plurality of portions of an insulating panel in accordance with an embodiment of the present invention.

### DETAILED DESCRIPTION OF THE INVENTION

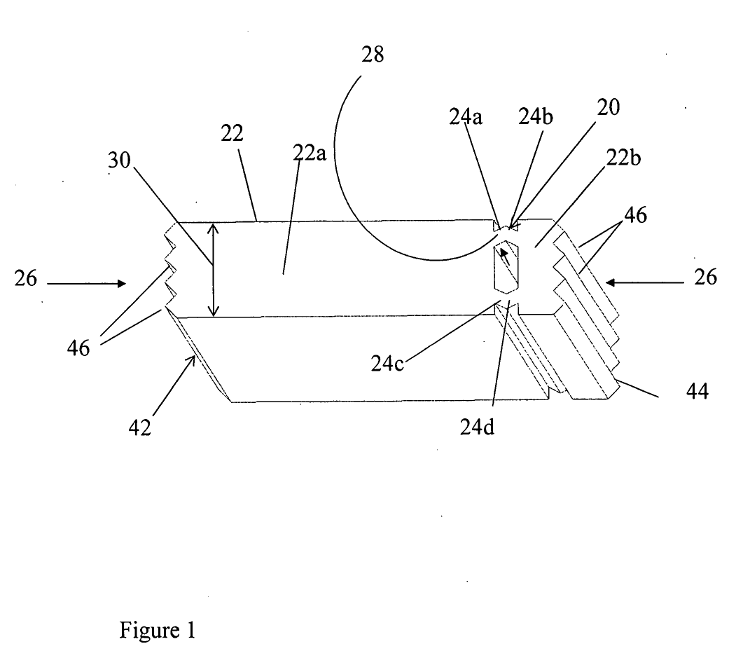

FIG. 1 illustrates one embodiment of a compressible joint 20 formed in an insulating panel 22 in accordance with the present invention. The compressible joint 20 includes one or more segments 24a, 24b, 24c, 24d (collectively “24”) configured to elastically or plastically deform when subjected to a compression force 26. In the illustrated embodiment, the segments 24 of the compressible joint 20 form a closed structure. As used herein, “compressible joint” refers to a structure configured to deform when subjected to a compressive force. The compressible joint preferably deforms, at least in part, elastically so as to generate an expansion force.

In operation, the compression force 26 is typically provided by an operator preparing to insert the insulating panel between a pair of opposing surfaces, such as between adjacent wall studs. In another embodiment, the insulating panel 22 can be subject to a compressive force as part of an automated assembly procedure, such as illustrated in U.S. Patent Application No. 2008/0168741 (Gilgan et al.) which is hereby incorporated by reference.

The segments 24 preferably have a cross-sectional thickness 28 less than the cross-sectional thickness 30 of the insulating panel 22. This differential in thickness 28 vs. 30 facilitates deformation of the segments 24 without deforming first and second portions 22a, 22b of the insulating panel 22. In the preferred embodiment, the total thicknesses 30 of the segments 24a, 24b plus the thicknesses of the segments 24c, 24d is preferably at least 2 inches so as to obviate a vapor barrier.

In the illustrate embodiment, the segments 24 are angled with respect to each other and the first and second portions 22a, 22b of the insulating panel 22. Although the embodiment of FIG. 1 illustrates a compressible joint 20 with four linear segments, the number of segments and their shapes can vary. For example, a single curvilinear segment can be used.

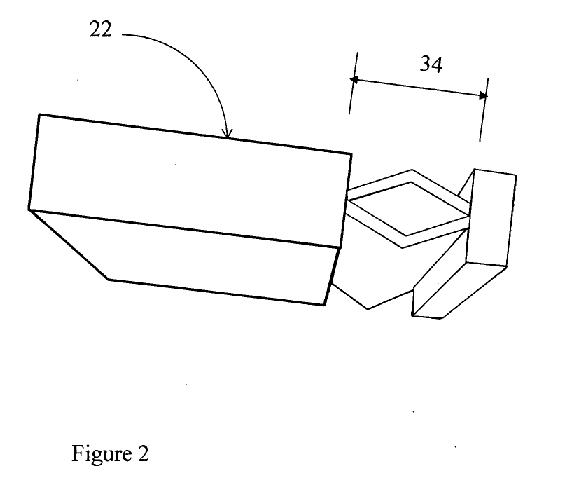

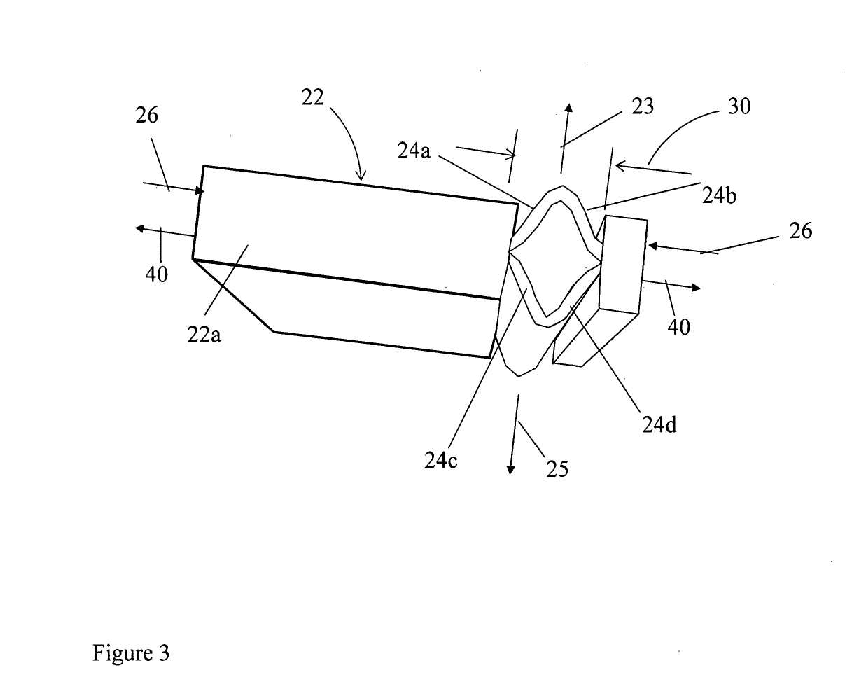

FIGS. 2 and 3 provide a finite element analysis of the insulating panel 22 with and without the compression force 26. Deformation around the compressible joint 20 is preferably symmetrical, resulting in a very low out of plane forces acting on the compressible joint 20 which is desirable so the panel 22 does not tend to pop out of the wall.

As is best illustrated in FIG. 3, the compression force 26 causes the segments 24a and 24b to flex upward in a direction 23 and the segments 24c and 24d to flex downward in a direction 25, reducing gap 34 between first and second portions 22a, 22b of the insulating panel 22 to the gap 30.

The amount of displacement (gap 34 minus gap 30) of the first portion 22a relative to the second portion 22b can vary with the application, the thickness of the insulating panel 22, and a variety of other factors. In one embodiment, the maximum displacement possible is preferably about one inch for each compressible joint 20. In operation the user preferably cuts a section of insulating panel 22 less than about one inch larger than the space between the wall studs. Consequently, the section of insulating panel 22 can be compressed a sufficient amount to fit in the space.

In an embodiment where the compressible joint deforms, at least in part, elastically, the compressible joint 20 generates expansion force 40. As will be discussed below, this expansion force 40 can be used to retain the insulating panel 22 between opposing surfaces, such as for example studs in a wall structure. Due to plastic deformation, the expansion force 40 is typically less than the compression force 26.

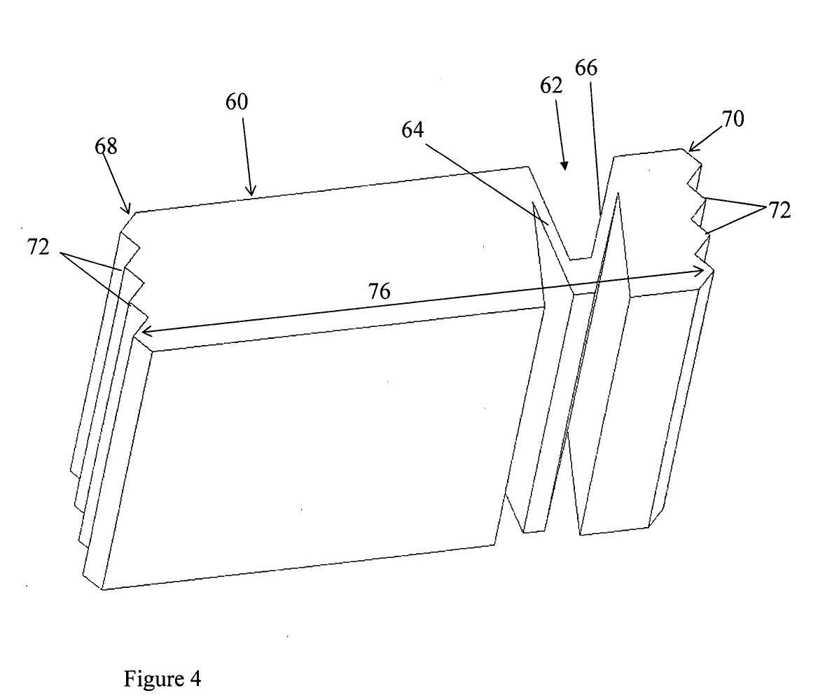

Turning back to FIG. 1, side edges 42, 44 of the insulating panel 22 preferably include fins 46 or other structures that are deformable by the expansion force 40 to form a seal with an opposing structure. The fins 46 can deform elastically or plastically. The deformed fins 46 preferably form an air-tight seal with the opposing structure. The insulating panel 22 is preferably sized to permit insertion in standard stud to stud spacing (see e.g., FIG. 4), while the expansion force 40 insures that the fins located at each end of the insulation panel 22 are compressed against the wall studs to form an air tight seal.

FIG. 4 illustrates an alternate insulating panel 60 in accordance with an embodiment of the present invention. Compressible joint 62 includes a pair of segments 64, 66 forming a generally V-shaped structure. The segments 64, 66 form an open structure compared to the closed structure of the compressible joint 20 in FIG. 1. A variety of compressible joints can be considered which would fulfill the function of applying a lateral load and to deform the panel to fit into existing stud-to-stud spacing. Compressible joint shapes such as V-shaped, W-shaped, X-shaped, or a combination thereof can readily be used depending on the manufacturing process and available tooling.

In the illustrated embodiment, side edges 68, 70 of the panel 60 also include a plurality of fins 72 for forming a seal with another structure. The fins 72 are not limited to triangular shapes can be extended to include more compliant structures such as high aspect ration geometrical shapes to conform to stud-to-stud spacing.

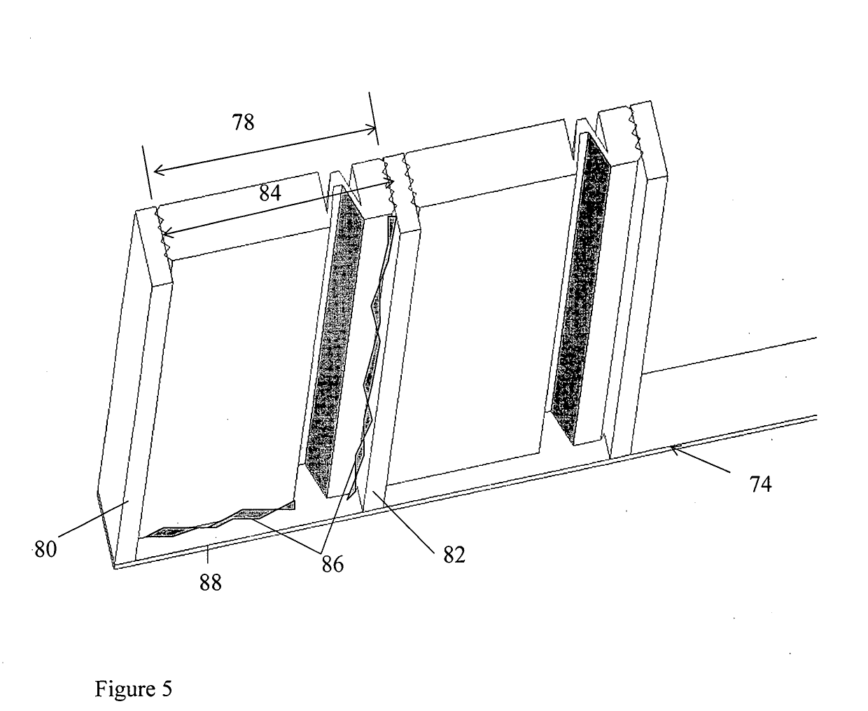

FIG. 5 illustrates the insulating panel 60 located in a wall structure 74. In the uncompressed state (see e.g., FIG. 4), the insulating panel 60 has a width 76 slightly larger than spacing 78 between opposing studs 80, 82. In the compressed state (see FIG. 5) the compressible joint 62 is deformed so that width 76 is now slightly smaller than the spacing 78 between the studs 80, 82. When placed between the studs 80, 82 the compressible joint 62 exerts an expansion force 84 that retains the insulating panel 60 in place. The fins 72 preferably deform to form a seal with the studs 80, 82.

In one embodiment, an additional sealing 86, such as caulk or foam, is applied to the perimeter of the insulating panel 60 to improve the seal with the studs 80, 82, 88. In another embodiment, a foam material is applied to the compressible joint 62 to increase the insulating properties of the panel 60 in that location.

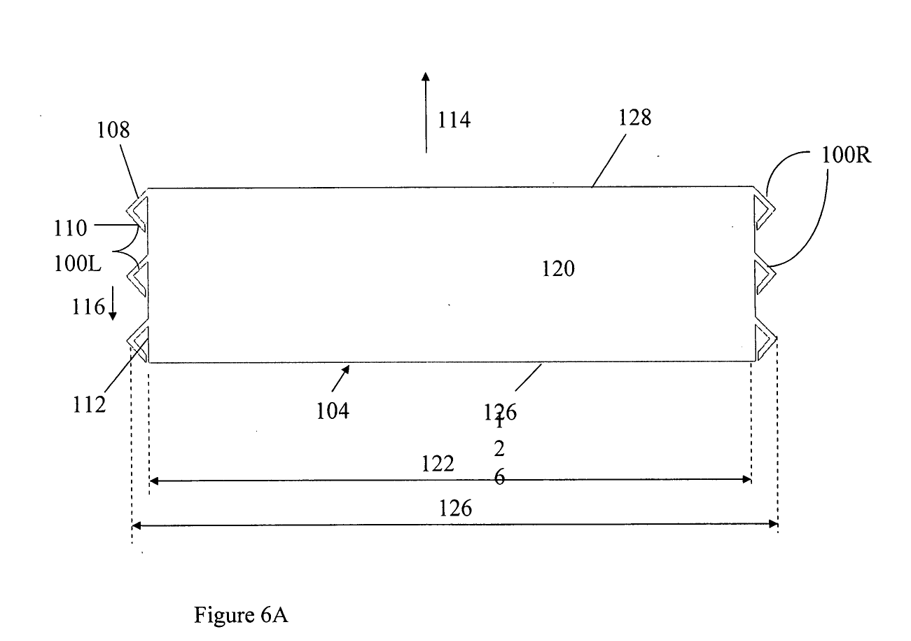

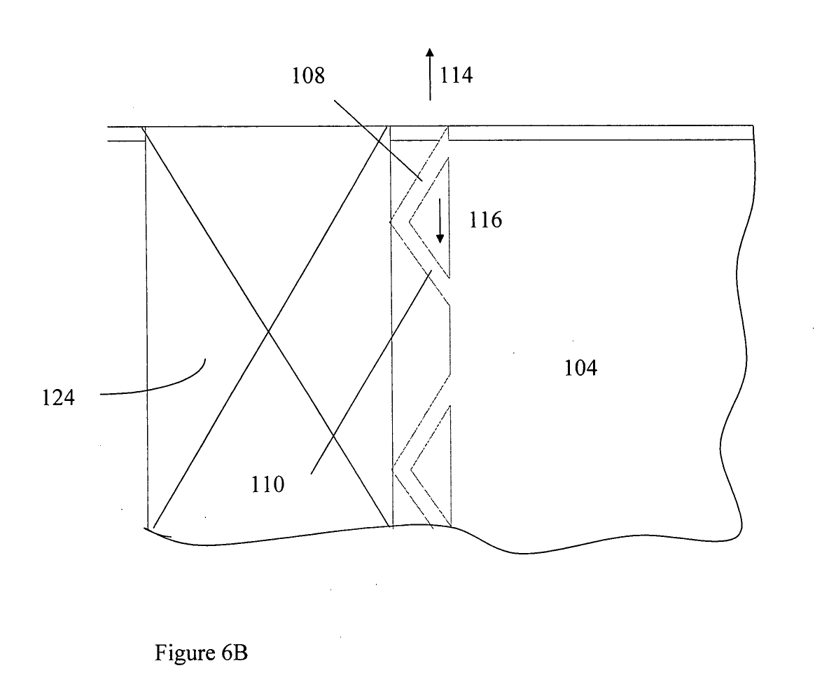

FIG. 6A illustrates an alternate insulating panel with a plurality of compressible joints 100L and 100R (collectively “100”) that also function as fins to seal against an opposing surface. In the illustrated embodiment, the compressible joints 100 include multiple pairs of segments 108, 110 in a V-shape configuration attached to one or both edges 112 of the insulating panel 104. Segment 108 is attached to the edge 112, but segment 110 is not.

In the embodiment of FIG. 6A, the compressible joints 100R are off-set closer to first major surface 126 of the insulating panel 104, while the compressible joints 100L are off-set closer to the second major surface 128. This configuration permits that insulating panel 104 to be angle during engagement with a wall segment. For example, the compressible joints 100L are inserted first.

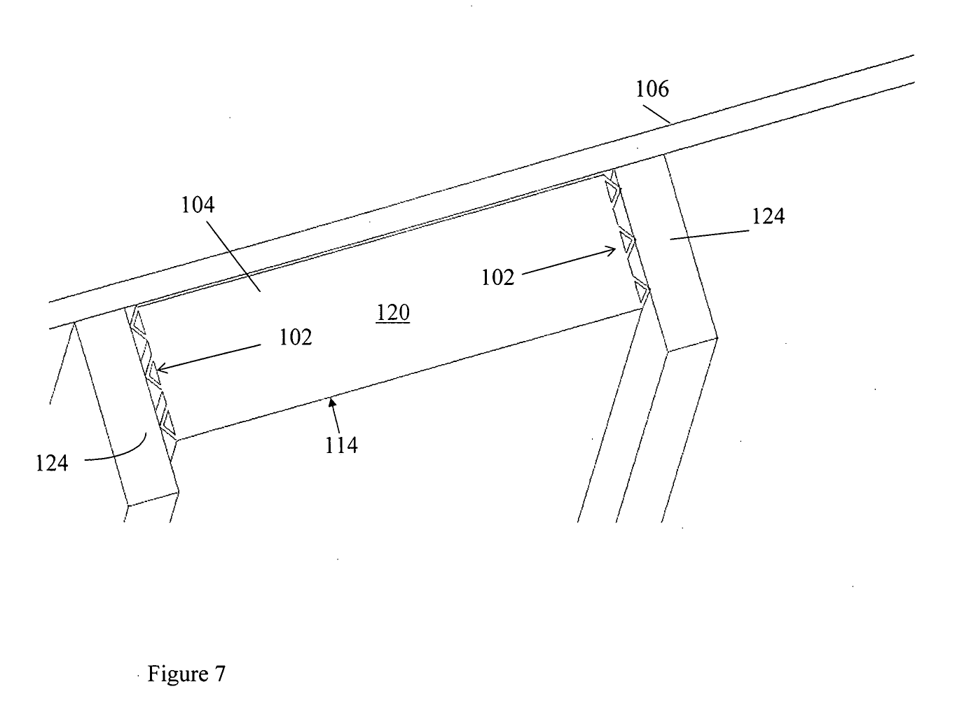

In an embodiment where the compressible joints 100 are the sole compressible joints, the central portion 120 of the insulating panel 104 (excluding the compressible joint 100) preferably has a width 122 less than the width between studs 124 (see FIG. 7). The total width 126 of the insulating panel 104 with the compressible joint 104 is preferably greater than the width between the studs 124. Consequently, the compressible joint 100 provides an interference fit between the studs 124.

As best illustrated in FIGS. 6B and 7, as the insulting panel 104 is inserted into the wall structure 106 in direction 114, the segments 108, 110 (see FIG. 6B) are displaced and deformed in the opposite direction 116. Once the insulating panel 104 is in place, the segments 108, 110 attempt to return to their undeformed state and apply an expansion force 102 against the stud 124 to retain the insulting panel 104 in the wall structure 106. (See FIG. 7). The compressible joint 100 can be used alone or in combination with one or more compressible joints in central portion 120 of the insulating panel 104.

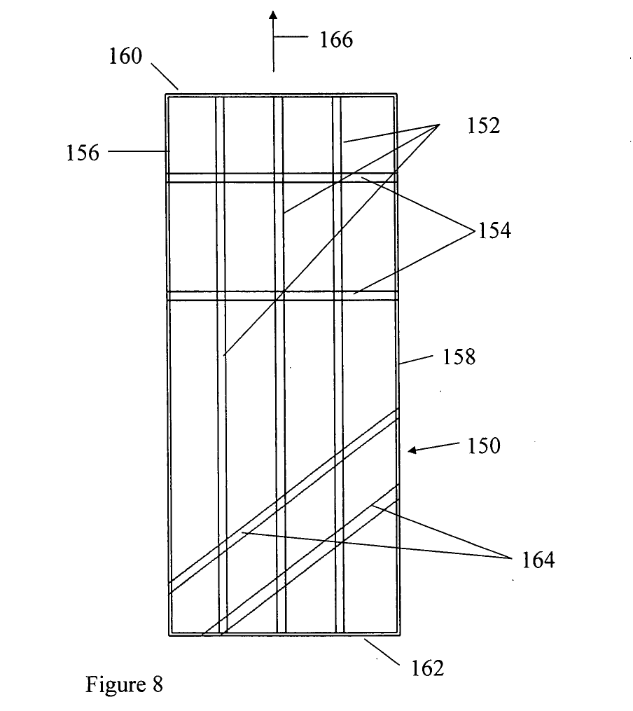

FIG. 8 illustrates an insulating panel 150 with a plurality of compressible joints 152 in accordance with an embodiment of the present invention. Insulating panels are typically provided in standard sizes, such as for example 4 feet by 8 feet. A standard insulating panel preferably has compressible joints at predetermined intervals, such as every 12 inches, 16 inches, 18 inches, 24 inches, or some combination thereof. The compressible joints 152 provide convenient score lines for cutting or snapping the insulating panel 150 into the desired widths.

In another embodiment, the insulating panel 150 includes a compressible joint 152 every 4 or 6 inches. Consequently, for most applications the cut sections of insulating panel 150 will have a plurality of compressible joints 152. This embodiment is desirable to minimize the deformation of any single compressible joint 152.

The insulating panel 150 optionally includes compressible joints 154 generally perpendicular to compressible joints 152. The compressible joints 152, 154 permit compression in two degrees of freedom.

In an embodiment where the compressible joints 152 are formed during extrusion of the insulating panel 150, the compressible joints 154 are typically formed using a machining or cutting process, such as for example with a heated cutting tool. Edges 156, 158, 160, 162 preferably include fins or an additional compressible joint (see e.g., FIG. 6).

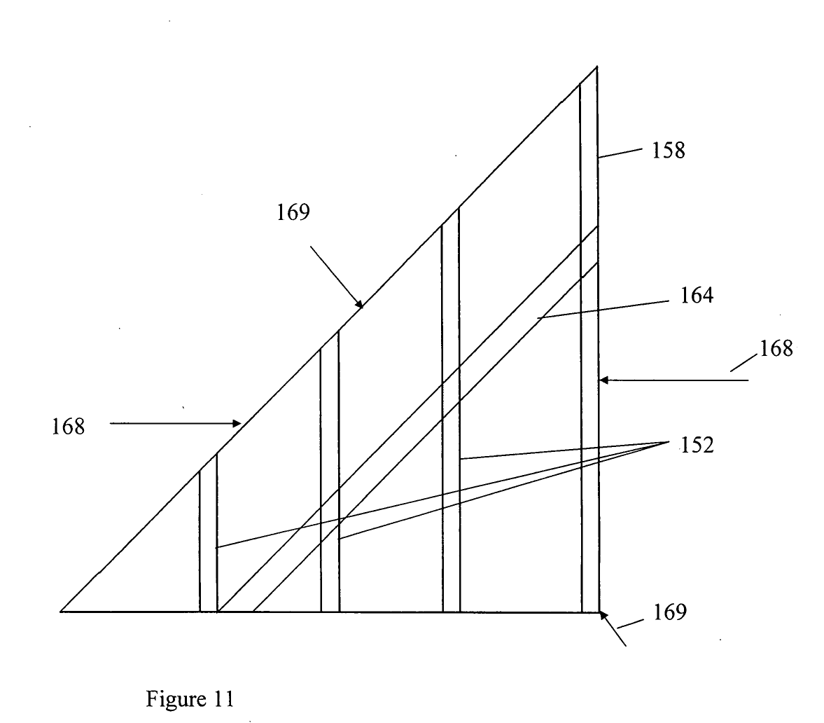

In another embodiment, compressible joints 164 are optionally formed at an angle with respect to major axis 166 of the insulating panel 150. Angled compressive joints 164 are particularly useful for non-rectangular sections of the insulating panel 150, such as illustrated in FIG. 11. The compressible joints 152 permit compression in the directions 168, while the angled compressible joint 164 permits compression in the directions 169.

The present invention is applicable to any type of insulating material, but preferably with a rigid, closed cell foam material that can be extruded, such as disclosed in U.S. Pat. Nos. 4,623,673 (DeGuiseppi et al.); 5,008,299 (Tucker et al.); 5,523,334 (White et al.); and 5,547,998 White et al.), which are hereby incorporated by reference. The insulating foam can be monolithic or a multilayered structure, such as disclosed in U.S. Pat. No. 4,764,420 (Gluck et al.) or 4,938,819 Ishii et al.), which are hereby incorporated by reference. In some embodiments, a foil, woven or non-woven layer, or other material can be laminated or applied to one or both surfaces of the insulating panel, such as disclosed in U.S. Pat. No. 4,121,958 (Koonts), which is hereby incorporated by reference. In another embodiment, a flexible sheeting is co-extruded with the insulating panel.

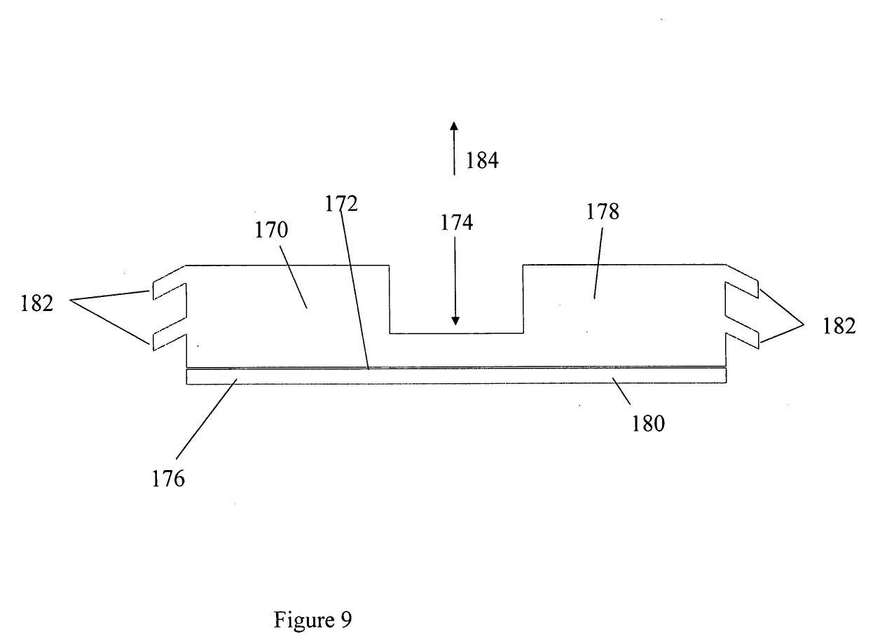

FIG. 9 is a sectional view of a composite insulating panel 170 in accordance with an embodiment of the present invention. In one embodiment, a flexible sheet 172 is co-extruded with the insulating panel 170. The flexible sheet 172 preferably extends the full width of the insulating panel 170. In another embodiment the flexible sheet 172 is located primarily in the compressible joint 174. In another embodiment, a flexible sheet 176 is co-extruded or laminated to one or both major surfaces 178, 180 of the insulating panel 170. The flexible sheets 172, 176 can be a woven or non-woven polymeric material, a foil, a mesh or scrim, or a variety of other structures.

The embodiment of FIG. 9 includes directional fins 182. The fins 182 are intended to be inserted into the wall structure in the direction 184. As a result, the fins deflect inward toward the insulating panel 170 during insertion, but form a barb-structure with the studs to resist removal. As used herein, “directional fins” refers to a structure configured for preferential insertion in one direction.

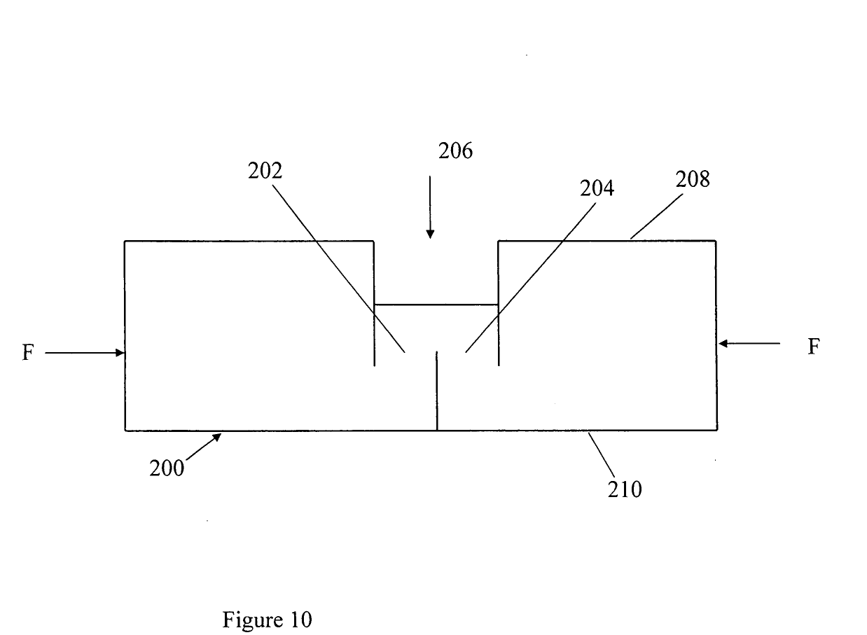

FIG. 10 is a sectional view of an insulating panel 200 in accordance with an embodiment of the present invention in a fully compress configuration. Segments 202, 204 of compressible joint 206 are preferably design to not extend above or below major surfaces 208, 210 of the insulating panel 200, even when fully compressed. This configuration reduces the risk that the deformed compressible joint 206 will displace the major surfaces 208, 210 away from the wall structure. The embodiment of FIG. 10 also maximizes the insulating value of the insulating panel 200.

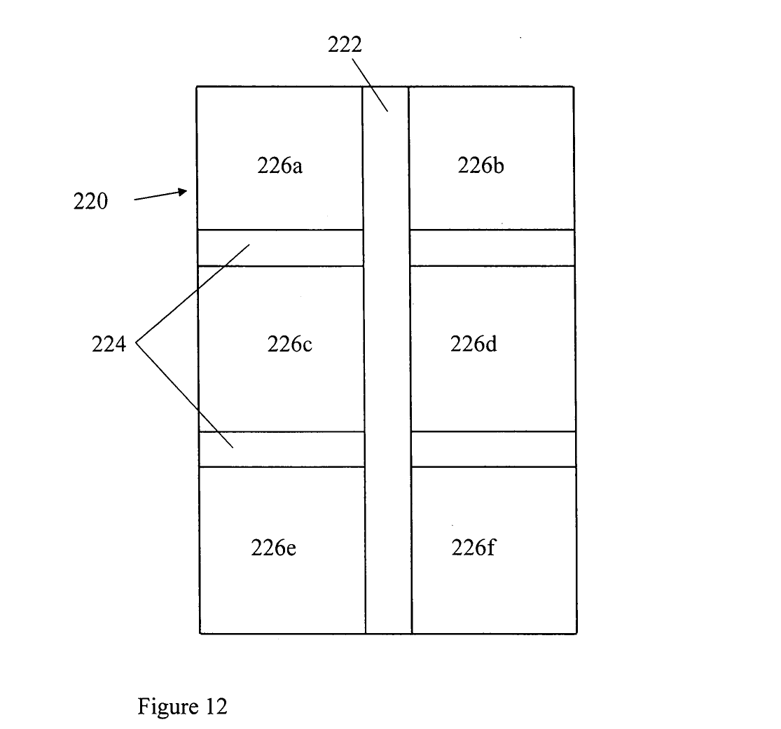

FIG. 12 illustrates an insulating panel 220 with both vertical compressible joints 222 and horizontal compressible joints 224. The compressible joints 222, 224 permit each section 226a, 226b, 226c, 226d, 226e, 226f (collectively “226”) of the insulating panel 220 to move independently in three degrees of freedom—along the X-axis, the Y-axis and rotation around the Z-axis. The embodiment of FIG. 12 permits a higher degree of compliance, and hence a better seal, with the opposing surfaces with which the insulating panel 220 engages.

The compressible joints and/or fins of the present invention are preferably integrally formed in the insulating panel during manufacturing. In particular, the compressible joint and/or fins are made from the same material and are part of the insulating panel. In the preferred embodiment, the die used to extrude the insulating panel includes features that form the compressible joint and/or fins during manufacture of the insulating panels. In an alternate embodiment, the compressible joints and/or fins can be cut after the insulating panel is extruded using a variety of techniques, such as with a heated cutting tool.

Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains many specificities, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. An insulating panel comprising:
a panel structure of closed cell foam comprising a first portion and a second portion; and
at least one compressible joint connecting the first portion to the second portion, the compressible joint comprising at least one segment with a cross-sectional thickness less than a cross-sectional thickness of the panel structure.

2. The insulating panel of claim 1 wherein the compressible joint is elastically deformable in response to a compressive force is applied to side edges of the panel structure.

3. The insulating panel of claim 1 wherein the segment is oriented at an angle with respect to first and second major surfaces of the panel structure.

4. The insulating panel of claim 1 wherein the segment comprises a curvilinear shape.

5. The insulating panel of claim 1 wherein the compressible joint comprises a closed structure.

6. The insulating panel of claim 1 wherein the segments are configured to deform symmetrically in response to a compression force is applied to side edges of the panel structure.

7. The insulating panel of claim 1 wherein the compressible joint in a fully compressed configuration is located substantially between first and second major surfaces of the panel structure.

8. The insulating panel of claim 1 wherein the compressible joint in a compressed configuration generates an expansion force generally parallel to first and second major surfaces of the panel structure.

9. The insulating panel of claim 1 comprising at least one deformable fin located on side edges of the panel structure.

10. The insulating panel of claim 1 comprising a plurality of directional fins located on side edges of the panel structure.

11. The insulating panel of claim 1 comprising a plurality of non-parallel compressible joints.

12. The insulating panel of claim 1 wherein the compressible joints comprise score lines for cutting or snapping the insulating panel into the desired sizes.

13. The insulating panel of claim 1 wherein the compressible joint permits the first portion of the panel structure to move in at least two degrees of freedom relative to the second portion of the panel structure.

14. The insulating panel of claim 1 wherein major surfaces of the panel structure comprise a non-rectangular shape.

15. The insulating pane of claim 1 wherein the panel structure and the compressible joint comprises a monolithic structure.

16. The insulating panel of claim 1 wherein the first and second portions and the compressible joint comprises a unitary structure integrally formed from the closed cell foam.

17. The insulating panel of claim 1 wherein the compressible joint comprises a multi-layered structure.

18. An insulating panel comprising:
a panel structure of closed cell foam comprising a plurality of side edges; and
at least one compressible joint extending along at least of one of the side edges, the compressible joint comprising at least one segment with a cross-sectional thickness less than a cross-sectional thickness of the panel structure, 1 wherein the first and second portions and the compressible joint comprises a unitary structure integrally formed from the closed cell foam.

19. A method of installing an insulating panel comprising the steps of:
sizing a panel structure slightly larger than a space between to opposing surfaces;
applying a compressive force to a compressible joint connecting first and second portion of the panel structure so the insulating panel is slightly smaller than the space between the opposing surfaces;
locating the insulating panel between the opposing surfaces;
releasing the compressive force; and
generating an expansion force in the compressible joint that is transmitted through the first and second portions of the panel structure to the opposing surfaces.

20. The method of claim 19 comprising engaging fins on side edges of the first and second portions with the opposing surfaces.
